(19) United States
(12) Patent Application Publication
(10) Pub. No.: US 2026/0110447 A1
(43) Pub. Date: Apr. 23, 2026

(54) OPERATION CONTROL METHOD OF DESICCANT DEHUMIDIFIER ACCORDING TO OUTSIDE AIR TEMPERATURE

(71) Applicants: Seung Tae PARK, Siheung-si Gyeonggi-do (KR); Eun Gu PARK, Siheung-si Gyeonggi-do (KR); AIR-TECH ENGINEERING CO., LTD., Siheung-si Gyeonggi-do (KR); ROOTAIR INC., Seoul (KR); SHINSUNG E&G CO., LTD., Gwacheon-si (KR)

(72) Inventors: Seung Tae PARK, Siheung-si Gyeonggi-do (KR); Eun Gu PARK, Siheung-si Gyeonggi-do (KR); Hyun Ju LEE, Seoul (KR); Sung Ku CHO, Ansan-si Gyeonggi-do (KR); Kyoung Su HONG, Suwon-si Gyeonggi-do (KR); Gyung HWANGBO, Incheon (KR); Na Hong LEE, Yongin-si Gyeonggi-do (KR); Bong Jin KIM, Goyang-si Gyeonggi-do (KR); Sung Hak JUNG, Goyang-si Gyeonggi-do (KR); Ju Sig KIM, Suwon-si Gyeonggi-do (KR); Hyuk Joong KWON, Seoul (KR)

(21) Appl. No.: 19/428,311

(22) Filed: Dec. 22, 2025

Related U.S. Application Data
(63) Continuation of application No. PCT/KR2024/014747, filed on Sep. 27, 2024.

(30) Foreign Application Priority Data
Oct. 24, 2023 (KR) 10-2023-0142705

(51) Int. Cl. F24F 3/14; B01D 53/06; B01D 53/26; F24F 110/20

(52) U.S. Cl. CPC F24F 3/1423; B01D 53/06; B01D 53/261; B01D 2257/80; B01D 2259/4009; B01D 2259/4508; F24F 2003/144; F24F 2003/1464; F24F 2110/20; F24F 2203/1032

(57) ABSTRACT

Provided is a method for controlling a desiccant dehumidifier according to the outdoor air temperature, thereby enabling year-round operation of a single integrated dehumidifier despite seasonal variations. More specifically, the invention regulates the areas of the process, purge, and regeneration sections of the desiccant rotor in response to the outdoor air temperature and adjusts the outdoor air supply, thereby enhancing dehumidification efficiency.

### BACKGROUND

### Field

The present invention relates to an operation control method of a desiccant dehumidifier according to outside air temperature. More specifically, the operation control method of the present improves dehumidification efficiency by adjusting the areas of a process section and a purge section of a desiccant dehumidifier and changing an outside air supply section according to outside air temperature.

### Technology Underlying the Invention

### Description of the Related Art

In general, industrial dehumidifiers employ a dehumidification system that controls the humidity of the air to lower its moisture level when supplying air to the dehumidified space where production processes are carried out, in order to minimize problems caused by moisture in battery manufacturing, as well as in food and pharmaceutical production.

In applying a desiccant dehumidifier to the manufacturing processes or storage of such products, utilizing high-temperature outdoor air in summer increases dehumidification capacity. In this case, the dehumidifier is operated with an air volume ratio in the process section (desiccant area) of 4 and an air volume ratio in the regeneration section (desiccant area) of 1. However, this summer-mode operation cannot be used when the dehumidification load is high and the relative humidity is below 10%.

FIG. 1 illustrates a conventional summer operation method of a desiccant dehumidifier. Outdoor air (OA) enters from the upper right, is heated by a heater (h), and passes through the regeneration section (10a) of the desiccant rotor (R). The moisture adsorbed by the rotor is removed and exhausted as exhaust air (EA). Meanwhile, return air (RA) from the dehumidified space is driven by the blower fan (f1), passes through the process section (10b) of the rotor where moisture is removed, and is supplied back into the dehumidified space as supply air (SA).

At this time, the regeneration air for the desiccant rotor uses outdoor air (OA), and the supply air (S.A) for the dehumidified space uses return air (R.A) from the dehumidified space.

When the outdoor temperature in the mid-season and winter is 12° C. or lower, the desiccant dehumidifier is operated with an air volume ratio (desiccant rotor area) of 3 for the process section, 1 for the regeneration section, and 1 for the purge section.

FIG. 2 illustrates a conventional method of operating a desiccant dehumidifier during the mid-season and winter. As shown therein, return air (R.A) introduced from the lower left side is supplied to a desiccant rotor by means of a supply fan (f1), and is then branched into a process section (10b) and a purge section (10c). At this time, an air volume ratio of three (3) is supplied to the process section (10b), and an air volume ratio of one (1) is supplied to the purge section (10c). The air supplied to the process section (10b) is dehumidified by removal of moisture therein, and the resulting dehumidified supply air (S.A) is then delivered to the dehumidified space. Meanwhile, the air supplied to the purge section (10c) is preheated in the purge section and subsequently reheated by a heater (h), and then passes through a regeneration section (10a) of the desiccant rotor so as to remove moisture adsorbed to the desiccant rotor, after which it is discharged as exhaust air (E.A).

When the outdoor temperature during the mid-season or winter is 12° C. or lower, the process air volume is reduced to a ratio of 3 and a purge section is added. Consequently, the volume of dehumidified air discharged from the process section decreases, and the outlet temperature of the process section can be lowered. Thus, it becomes unnecessary to use a downstream cooling coil to cool the heated dehumidified air, or alternatively, the cooling load is reduced, thereby achieving energy savings.

Prior Patent Document: Korean Patent No. 10-1196775 (Registered Oct. 26, 2012)

### SUMMARY

In order to solve the problem that separate desiccant dehumidifiers for summer operation and for mid-season/winter operation must be provided for dehumidification, the present invention has been devised to integrate the desiccant dehumidifier into a single system, such that dehumidification can be controlled by one dehumidifier even when the outdoor temperature changes throughout the year. More specifically, the proposes of the invention is to provide a method of operating and controlling a desiccant dehumidifier according to the outdoor temperature, wherein the areas of a process section, a regeneration section, and a purge section of a desiccant rotor are controlled, and the outdoor air supply section is switched, thereby improving dehumidification efficiency.

According to one aspect of the present invention, a method of operating and controlling a desiccant dehumidifier according to the outdoor air in the summer comprises: supplying return air (201) of a dehumidified space to a process section (105) of a desiccant rotor (104) by means of a supply fan (102) to obtain process air (205) dehumidified by adsorption; supplying the return air (201) of the dehumidified space to a purge section (106) of the desiccant rotor (104) by means of the supply fan (102) to obtain purge air (206) dehumidified by adsorption; combining the dehumidified process air (205) and the dehumidified purge air (206) and supplying the combined air to the dehumidified space; heating outdoor air (207) in a regeneration heater (109) and supplying the heated outdoor air to a regeneration section (107) of the desiccant rotor (104) so as to thermally desorb moisture adsorbed to the desiccant rotor, and discharging the desorbed moisture as regeneration exhaust air (209); wherein three-fifths (⅗) of the total area of the desiccant rotor (104) is used as the process section (105), one-fifth (⅕) of the total area is used as the purge section (106), and one-fifth (⅕) of the total area is used as the regeneration section (107).

According to another aspect of the present invention, a method of operating and controlling a desiccant dehumidifier according to the outdoor air in the mid-season and winter comprises: supplying return air (201) of a dehumidified space to the process section (105) of the desiccant rotor (104) by means of the supply fan (102) to obtain dehumidified process air (205) and supplying the dehumidified process air (205) to the dehumidified space; supplying the return air (201) of the dehumidified space to the purge section (106) of the desiccant rotor (104) by means of the supply fan (102) to obtain purge air (206) dehumidified by adsorption, heating the purge air (206) in a regeneration heater to form regeneration heated air (208), supplying the regeneration heated air (208) to the regeneration section (107) of the desiccant rotor (104) to thermally desorb moisture adsorbed to the desiccant rotor, and discharging the desorbed moisture as regeneration exhaust air (209); wherein three-fifths (⅗) of the total area of the desiccant rotor (104) is used as the process section (105), one-fifth (⅕) of the total area is used as the purge section (106), and one-fifth (⅕) of the total area is used as the regeneration section (107).

According to a further aspect of the present invention, the method of operating and controlling a desiccant dehumidifier according to the outdoor air is characterized in that humidity control of the dehumidified space is performed by detecting the humidity of the return air (201), and in a case where the detected humidity exceeds a predetermined value, the heating temperature of the regeneration heater is increased.

According to still another aspect of the present invention, the method of operating and controlling a desiccant dehumidifier according to the outdoor air is characterized in that a precooler for cooling purge outdoor air is additionally provided in accordance with the target humidity of the dehumidified space in summer.

The present invention provides the effect of reducing installation costs of a desiccant dehumidifier, since the desiccant dehumidifier is integrated into a single section and can be operated by a single dehumidifier even when the outdoor temperature changes.

The present invention further provides the effect of lowering the humidity of the dehumidified space in the case where the target humidity of the dehumidified space in summer is low, by additionally providing a precooler for cooling purge outdoor air.

### BRIEF DESCRIPTION OF DRAWINGS

FIG. 1 is a flow diagram of dehumidified air in a conventional summer desiccant dehumidifier.

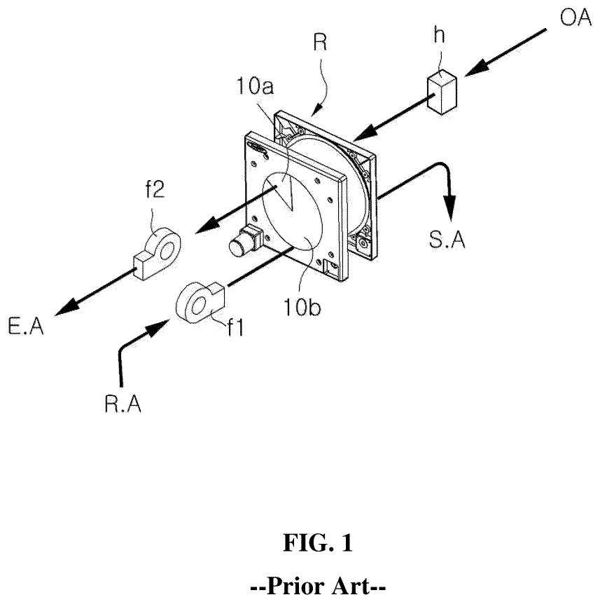

FIG. 2 is a flow diagram of dehumidified air in a conventional mid-season and winter desiccant dehumidifier.

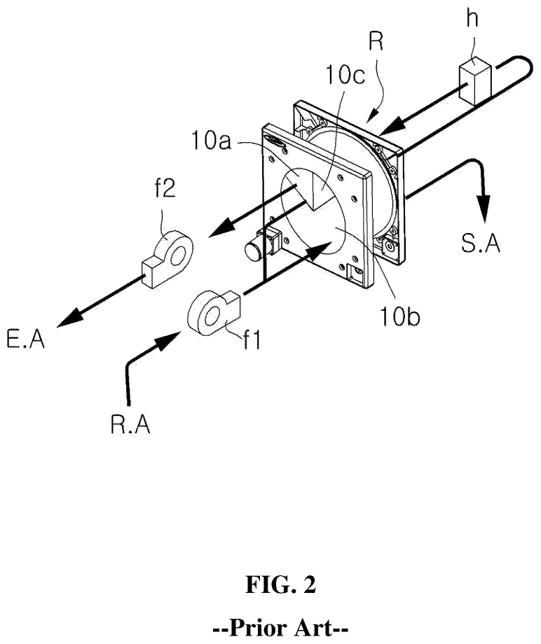

FIG. 3 is a configuration diagram of a desiccant dehumidifier according to the present invention.

FIG. 4 is a flow diagram of dehumidified air in a summer desiccant dehumidifier according to the configuration of FIG. 3.

FIG. 5 is a flow diagram of dehumidified air in a mid-season and winter desiccant dehumidifier according to the configuration of FIG. 3.

FIG. 6 is a configuration diagram of a desiccant dehumidifier according to the configuration of FIG. 3, further provided with a precooler for cooling outdoor air;

### DETAILED DESCRIPTION OF THE EMBODIMENT

Preferred embodiments of the present invention will now be described in detail with reference to the accompanying drawings. For convenience of explanation, the sizes, thickness of lines, and proportions of certain components illustrated in the drawings may be exaggerated.

In addition, the terminology used in the present specification has been defined in consideration of the functions of the present invention, and such terminology may vary depending on the intent or custom of a user or operator. Accordingly, the definitions of such terms should be interpreted based on the overall content of this specification.

In the description of the present invention, the terms “comprise,” “include,” and “have” are intended to specify the presence of the stated features, elements, steps, operations, components, and/or combinations thereof, but do not preclude the presence or addition of one or more other features, elements, steps, operations, components, and/or combinations thereof.

Although embodiments of the present invention are described herein by way of example, it will be apparent to those skilled in the art that the present invention may be embodied in various different forms. The purpose of describing certain embodiments is to ensure that the disclosure of the present invention is sufficient and to enable those skilled in the art to understand the spirit and scope of the present invention.

The present invention may be embodied in various modifications and alternatives; however, preferred embodiments are described in detail below. It should be understood that the embodiments are not intended to limit the present invention to the particular forms disclosed, but rather to encompass all modifications, equivalents, and alternatives falling within the technical spirit of the present invention. Unless otherwise specifically stated, singular expressions used herein may also encompass plural forms.

To clarify the gist of the invention, descriptions of well-known functions or structures that may obscure the essence of the invention are omitted.

The preferred embodiments of the present invention will now be described in detail with reference to the accompanying drawings.

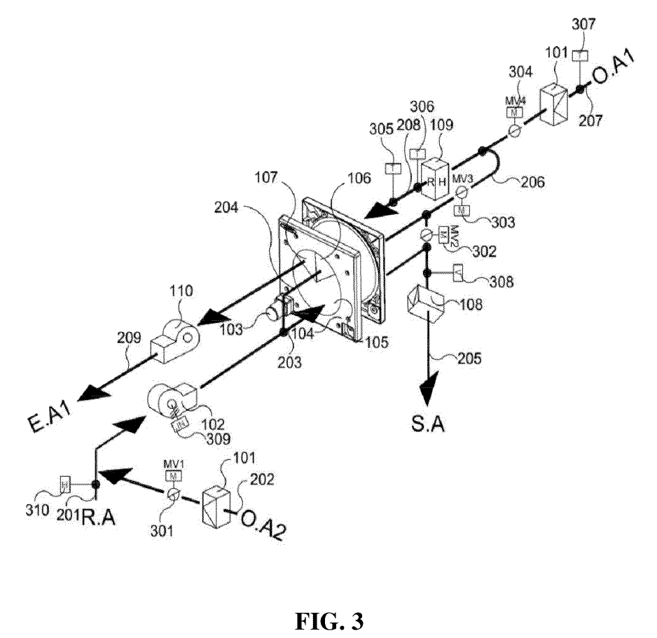

FIG. 3 is a configuration diagram of a desiccant dehumidifier according to the present invention.

As shown in FIG. 3, the desiccant dehumidifier according to the outdoor temperature is classified into a device section, an air section, and operation-control dampers and sensors.

The device section comprises: a pre-filter (101) for filtering foreign substances from outdoor air (O.A1); a process fan (102) for supplying air to the desiccant rotor (104); a geared motor (103) for driving the desiccant rotor; a desiccant process section (105); a desiccant purge section (106); a desiccant regeneration section (107); a supply filter (108) for filtering foreign substances from process air (203) supplied to the dehumidified space; a regeneration heater (109) for heating regeneration air supplied to the regeneration section of the desiccant rotor; a regeneration fan (110) for exhausting regeneration air to the outside; and a precooler (111) for cooling purge outdoor air (202) to be mixed with return air (201) of the dehumidified space.

In the above configuration, the desiccant rotor (104) is configured such that an air volume (rotor area) of three (3) is assigned to the process section (105), an air volume of one (1) is assigned to the purge section (106), and an air volume of one (1) is assigned to the regeneration section (107).

In summer operation, both the air volume (rotor area) of three (3) in the process section (105) and the air volume (rotor area) of one (1) in the purge section (106) act as the process section, so that the process section operates with a total air volume of four (4), while the regeneration section (107) is operated with an air volume of one (1). In mid-season and winter operation, the process section (105) operates with an air volume of three (3), and the purge section (106) operates with an air volume of one (1).

The airs comprises: return air (201) of the dehumidified space, purge outdoor air (202), process air (203), purge/process air (204), dehumidified air (205), outlet air of purge section (206), outdoor air (207), regeneration heated air (208), and regeneration exhaust air (209).

The operation-control dampers and sensors comprise: a purge outdoor air damper (301); a purge-process damper (302) for mixing purge outlet air (206) with dehumidified air (205); a purge damper (303); an outdoor air damper (304); a regeneration temperature control sensor (305); a regeneration over-temperature prevention thermocouple or sensor (306); an outdoor air temperature sensor (307); and a supply air velocity sensor (308).

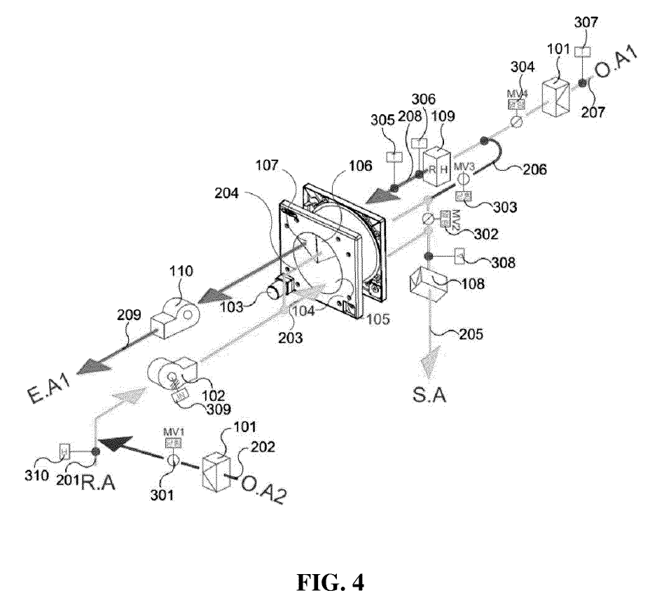

FIG. 4 is a flow diagram of dehumidified air in a summer desiccant dehumidifier according to the configuration of FIG. 3.

As shown in the airflow indicated in green, return air (201) ventilated from the dehumidified space is supplied by the process fan (102) to the purge section (106) and the process section (105) of the desiccant rotor (104). The process air dehumidified by adsorption in the purge section (106) and the process section (105) passes through the supply filter (108) and is supplied as dehumidified air (205) to the dehumidified space.

At this time, three-fifths (⅗) of the total area of the desiccant rotor (104) and one-fifth (⅕) of the total area thereof, both corresponding to the process section (105) and purge section (106), are effectively used as the process section, while one-fifth (⅕) of the total area is used as the regeneration section (107).

In this way, four-fifths (⅘) of the total area of the desiccant rotor is used as the process section, since the dehumidification load is relatively large in summer.

For regeneration of the desiccant rotor, as shown in the airflow indicated in yellow and red, the outdoor air damper (304) is opened, and outdoor air (207) is heated to about 140° C. in the regeneration heater (109) and passes through the regeneration section (107) of the desiccant rotor (104). The desorbed and regenerated air is discharged by the regeneration fan (110) as regeneration exhaust air (209) to the outside.

Humidity control is performed by controlling the regeneration heater (109) based on detection of humidity of the return air (201) by a humidity sensor (310). The supply airflow (205) is controlled to a set volume by an inverter (309 of the process fan (102) according to the supply air velocity sensor (308).

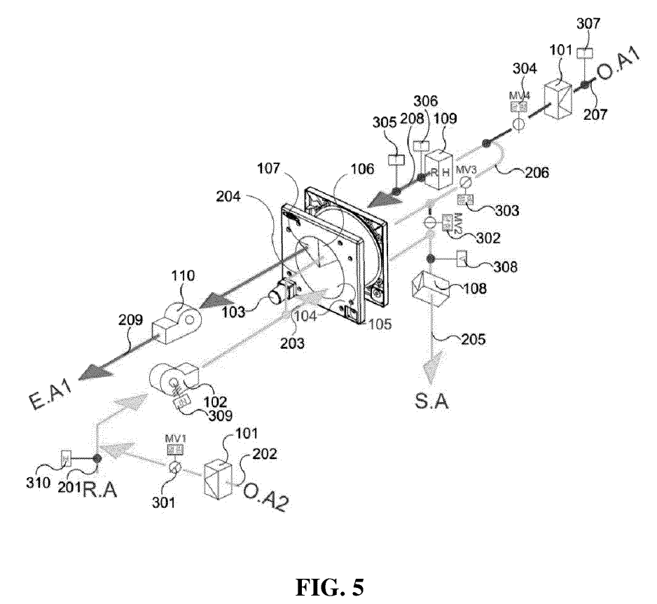

FIG. 5 is a flow diagram of dehumidified air in a mid-season and winter desiccant dehumidifier according to the configuration of FIG. 3.

As shown in the airflow indicated in green, when the temperature detected by the outdoor air temperature sensor (307) is 12° C. or lower, the purge outdoor air damper (301) is opened to mix return air (201) and outdoor air (202). The mixed air is branched into process supply air (203) and purge supply air (204), which are supplied to the process section (105) and the purge section (106), respectively.

In this case, three-fifths (⅗) of the total area of the desiccant rotor (104) is used as the process section (105), one-fifth (⅕) is used as the purge section (106), and one-fifth (⅕) is used as the regeneration section (107).

As shown in the airflow indicated in yellow, purge air (204) passing through the purge section (106) is heated by the regeneration heater (109) to form regeneration heated air (208). The regeneration heated air (208) passes through the regeneration section (107), thereby desorbing moisture adsorbed in the process and purge sections, and is discharged as high-humidity regeneration exhaust air (209) to the outside. In this case, the purge damper (303) is opened, the purge-process damper (302) is closed, and the outdoor air damper (304) is closed to block inflow of outdoor air to the regeneration section.

At the time of branching the mixed air into process supply air (203) and purge supply air (204), three-fourths (¾) of the mixed air is supplied to the process section (105), and one-fourth (¼) is supplied to the purge section (106). After three-fourths (¾) of the mixed air of the return air (201) and outdoor air (202) are supplied and dehumidified in the process section (105), the dehumidified air (205) is supplied to the dehumidified space.

According to the airflow indicated in red, the purge air (204) passing through the purge section (106) is heated by the regeneration heater (109) to become regeneration heated air (208). The regeneration heated air (208) then passes through the regeneration section (107), thereby performing a regeneration process to desorb moisture adsorbed in the process section and the purge section, and is subsequently discharged to the outside as high-humidity regeneration exhaust air (209).

Humidity control is performed by controlling the regeneration heater (109) based on detection of humidity of the return air (201) by the humidity sensor (310).

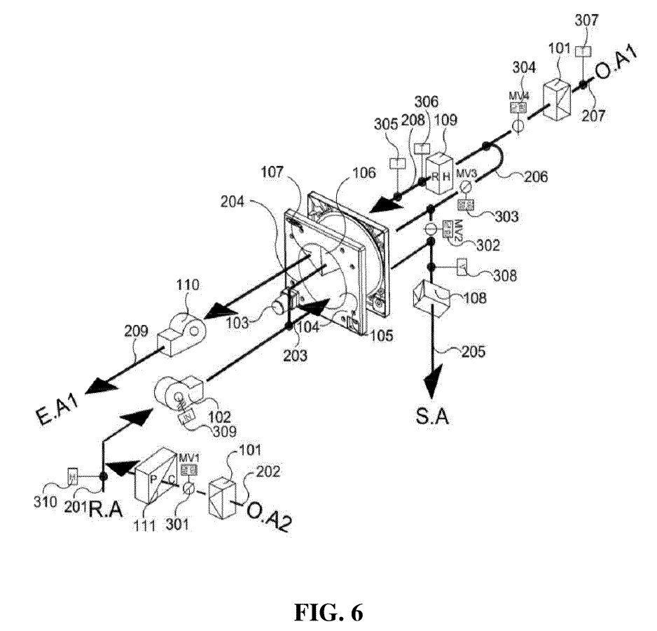

FIG. 6 is a configuration diagram of a desiccant dehumidifier according to the configuration of FIG. 3, further provided with a precooler for cooling outdoor air. In cases where low humidity is required even in summer, a precooler (111) is additionally provided in flow line of the purge outdoor air (202), so that the desiccant dehumidifier of FIG. 6 can maintain a relative humidity of 10% or less even in summer.

Although the invention made by the present inventors has been described in detail with reference to the embodiments above, the invention is not limited to the embodiments, but may be variously modified without departing from the spirit of the invention.

### EXPLANATION OF REFERENCE NUMERALS

101: Pre-filter
102: Process fan
103: Desiccant rotor geared motor
104: Rotor cassette/magic box of Desiccant
105: Desiccant process section
106: Desiccant purge section
107: Desiccant regeneration section
108: Supply filter
109: Regeneration heater
110: Regeneration fan
111: Precooler
201: Return air
202: Purge outdoor air
203: Process air
204: Purge or process air
205: Dehumidified air
206: Outlet air of purge section
207: Standard outdoor air
208: Regeneration heated air
209: Regeneration exhaust air

What is claimed is:

1. In a method of operating and controlling a desiccant dehumidifier according to the outdoor air in the summer comprises:
supplying return air (201) of a dehumidified space to a process section (105) of a desiccant rotor (104) by means of a supply fan (102) to obtain process air (205) dehumidified by adsorption;
supplying the return air (201) of the dehumidified space to a purge section (106) of the desiccant rotor (104) by means of the supply fan (102) to obtain purge air (206) dehumidified by adsorption;
combining the dehumidified process air (205) and the dehumidified purge air (206) and supplying the combined air to the dehumidified space;
heating outdoor air (207) in a regeneration heater (109) and supplying the heated outdoor air to a regeneration section (107) of the desiccant rotor (104) so as to thermally desorb moisture adsorbed to the desiccant rotor, and discharging the desorbed moisture as regeneration exhaust air (209);
wherein three-fifths (⅗) of the total area of the desiccant rotor (104) is used as the process section (105),
one-fifth (⅕) of the total area is used as the purge section (106), and
one-fifth (⅕) of the total area is used as the regeneration section (107).

2. In a method of operating and controlling a desiccant dehumidifier according to the outdoor air in the mid-season and winter comprises:
supplying return air (201) of a dehumidified space to the process section (105) of the desiccant rotor (104) by means of the supply fan (102) to obtain dehumidified process air (205) and supplying the dehumidified process air (205) to the dehumidified space;
supplying the return air (201) of the dehumidified space to the purge section (106) of the desiccant rotor (104) by means of the supply fan (102) to obtain purge air (206) dehumidified by adsorption, heating the purge air (206) in a regeneration heater to form regeneration heated air (208);
supplying the regeneration heated air (208) to the regeneration section (107) of the desiccant rotor (104) to thermally desorb moisture adsorbed to the desiccant rotor, and discharging the desorbed moisture as regeneration exhaust air (209);
wherein three-fifths (⅗) of the total area of the desiccant rotor (104) is used as the process section (105),
one-fifth (⅕) of the total area is used as the purge section (106), and
one-fifth (⅕) of the total area is used as the regeneration section (107).

3. The method of operating and controlling a desiccant dehumidifier according to the outdoor air according to claim 1, wherein it is characterized in that humidity control of the dehumidified space is performed by detecting the humidity of the return air (201), and in a case where the detected humidity exceeds a predetermined value, the heating temperature of the regeneration heater is increased.

4. The method of operating and controlling a desiccant dehumidifier according to the outdoor air according to claim 2, wherein it is characterized in that humidity control of the dehumidified space is performed by detecting the humidity of the return air (201), and in a case where the detected humidity exceeds a predetermined value, the heating temperature of the regeneration heater is increased.
